(19) United States
(12) Patent Application Publication
(10) Pub. No.: US 2010/0208729 A1
(43) Pub. Date: Aug. 19, 2010

(54) Method and System for Receiving Market Data Across Multiple Markets and Accelerating the Execution of Orders

(76) Inventors: John Oddie, Heathfield (GB); Ken Tregidgo, Acton (GB); Gareth Morris, London (GB)

Correspondence Address: The Marbury Law Group, PLLC, 11800 SUNRISE VALLEY DRIVE, SUITE 1000, RESTON, VA, 20191, US

(21) Appl. No.: 12/580,628

(22) Filed: Oct. 16, 2009

Related U.S. Application Data
(60) Provisional application No. 61/106,521, filed on Oct. 17, 2008.

(51) Int. Cl. H04L 12/56

(52) U.S. Cl. 370/389

(57) ABSTRACT

Systems and methods for utilizing a hardware acceleration solution that are capable of providing ultra-low latency with ultra-high throughput while maintaining consistent performance under a diverse range of market conditions. One or more data packets arrive at a network interface are read and passed through a protocol processing pipeline. At each protocol layer, the headers of the received data packets are inspected to assess whether the source IP address is a known source of financial message data. When the inspected data packet is not from a source of financial data, the inspected data packet may be discarded or processed as if received by a standard network interface. When the inspected packet is from a source of financial data, the data packet is forwarded to a filter. The packet is filtered in accordance with parameters established by a system user to select specific information of relevance to the system user. A low-latency data transfer application programming interface is used to transfer the relevant data through a high speed peripheral bus to a software subsystem of a host system.

### CROSS REFERENCE TO RELATED APPLICATIONS

This application claims priority under 35 U.S.C. §119(e) from provisional application No. 61/106,521 filed Oct. 17, 2008. The 61/106,521 application is incorporated by reference herein, in its entirety, for all purposes.

### BACKGROUND

Financial markets have undergone changes, both regulatory and in practice. Regulatory changes such as Regulation National Market System (Reg NMS) in the US and the Markets in Financial Instruments Directive (MiFID) as promulgated by the European Union have fostered increased competition by enabling new execution venues to compete on a more level playing field. The regulatory demands for best execution require consolidation of market data from multiple trading venues and the processing of price updates which are now approaching the millions of messages per second mark.

In order to maintain a competitive edge, trading firms have responded by changing their trading strategies and trading platform architectures to increase the speed of trading and cater to this ever-increasing volume growth. These firms and execution venues are adapting their trading architecture for ultra-low latency, removing unnecessary network hops, increasing market data distribution bandwidth and developing optimized software solutions on horizontally scalable low cost server platforms.

Latency is the time necessary to process the sale of a security and then to report that sale to the market. Latency time is typically measured in milliseconds. Low latency architecture for trading and reporting platforms is thus concerned with the efficiencies to be gained through changes in software approach and in the use of hardware solutions to reduce latency time. In the search for even lower latency, statistical arbitrage and algorithmic traders are also locating their price injectors as close to the trading engine as possible, leading to a growth in co-location services offered by execution venues. The challenges facing trading firms and execution venues can be summarized in terms of:

Capacity—which is moving from hundreds of millions to billions of order messages per day;

Throughput—which is moving from about a hundred thousand messages per second to millions of messages per second; and

Latency—which is moving from milliseconds to microseconds.

While progress has been made in the development of low latency trading architectures, software-only solutions typically suffer from higher intrinsic latency and degraded performance in faster markets. This intrinsic latency is due to the introduction of outliers, a failure to keep up, the need for higher server capacity.

Latency is inherent in the very software design architectures commonly used to facilitate exchange through the World Wide Web. While promoting design efficiency, architectures such as XML and Web Services actually foster latency when financial data streams are moving across platforms. Additionally, some software based solutions do not detect when data packets have been dropped from a data stream. Thus, when the stream is parsed and then re-directed, if a data packet is missing there is no high speed approach to re-attaching or re-creating the packet. This problem creates false or inaccurate trades because key data is missing when the data is formatted for end or dependent use. These problems necessarily impact statistical arbitrage and algorithmic traders.

### SUMMARY

Embodiments herein provide systems and methods for utilizing a hardware acceleration solution that are capable of providing ultra-low latency with ultra-high throughput while maintaining consistent performance under a diverse range of market conditions. Other embodiments provide systems and methods for maintaining the sequential integrity of data packets while maintaining consistent performance under a diverse range of market conditions. The systems and methods further provided for accelerating the decoding and filtering of message data to provide reduced latency of the message data while maintaining or increasing throughput.

An embodiment provides a method for accelerating the decoding and filtering of message data to provide reduced latency of the message data. One or more data packets that arrive at a network interface are read and passed through a protocol processing pipeline. At each protocol layer, the headers of the received data packets are inspected to assess whether the source IP address is a known source of financial message data. When the inspected data packet is not from a source of financial data, the inspected data packet may be discarded or processed as if received by a standard network interface. When the inspected packet is from a source of financial data, the data packet is forwarded to a filter. The packet is filtered in accordance with parameters established by a system user to select specific information of relevance to the system user. A low-latency data transfer application programming interface is used to transfer the relevant data through a high speed peripheral bus to a software subsystem of a host system.

### DESCRIPTION OF THE DRAWINGS

FIG. 1 is a pictorial schematic representing a system according to an embodiment.

FIG. 2 is a flowchart illustrating a process applied to packets in a pipeline according to an embodiment.

### DETAILED DESCRIPTION

Embodiments herein provide systems and methods for utilizing a hardware acceleration solution that is capable of providing ultra-low latency with ultra-high throughput while maintaining consistent performance under a diverse range of market conditions. Other embodiments provide systems and methods for maintaining the sequential integrity of data packets while maintaining consistent performance under a diverse range of market conditions. The systems and methods further provided for accelerating the decoding and filtering of message data to provide reduced latency of the message data while maintaining or increasing throughput.

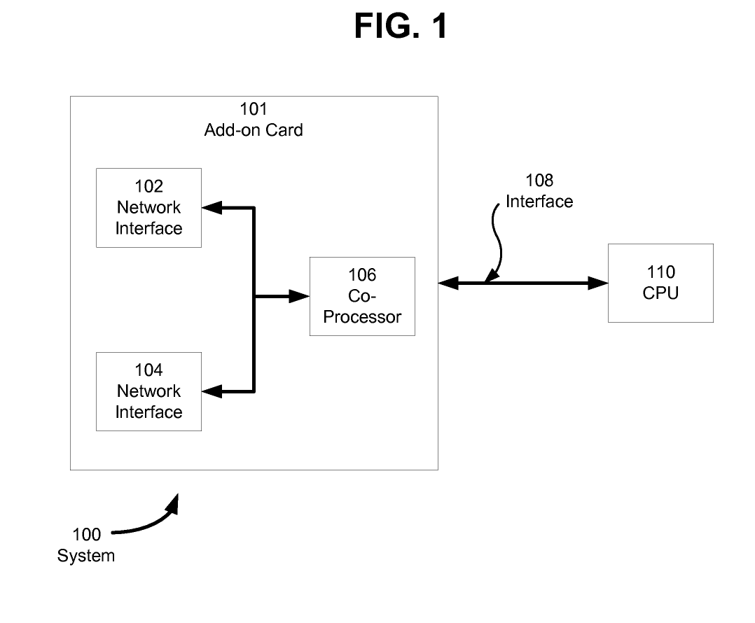

FIG. 1 is a high level pictorial schematic of a system according to an embodiment. The system 100 comprises an add-on card 101 and a CPU 110. The add-on card 101 and the CPU 110 communicate via a high-speed interface 108.

The add-on card 101 comprises a network port 102, a network port 104, and a co-processor 106. In an embodiment, add-on card 101 utilizes a co-processing architecture that may be configured to be plugged-in to a standard network server or stand-alone workstation. As illustrated, add-on card 101 includes network ports 102 and 104, however this is not meant as a limitation. Additional ports may be included on add-on card 101. In an embodiment, the network ports 102 and 104 provided connectivity to wired and fiber Ethernet network interfaces.

The network ports 102 and 104 are interoperably connected to the co-processor 106. The co-processor 106 may be a field programmable gate array (FPGA), an application specific integrated circuit (ASIC), or any form of parallel processing integrated circuit. The direct connection of the network ports to the coprocessor 106 eliminates one of the major contributors to latency in a hardware/software co-processing system that arises from the peripheral bus transactions between the system architecture (the co-processor architecture) and a network device.

The add-on card 101 implements a high-speed interface 108 such as HyperTransport, PCI-Express or Quick Path Interconnect to transfer data to and from the host system central processing unit (CPU) 110 with the highest bandwidth and lowest latency available. In an embodiment, the add-on card 101 is implemented to replace a central processing unit (CPU) in a socket on the motherboard of a host computing device (not illustrated).

Additionally, the system 100 may implement filtering on the content of the arriving messages, which filtering can be customized to a user's needs. By way of illustration and not by way of limitation, filtering may be performed by symbol, message type, price and volume. The filtering process acquires only the information that is of relevance to the user thereby reducing the CPU 110 loads for processing the feed. Messages can also be translated into a binary structure that can be read directly from the user's application, avoiding any processing time associated with converting message formats on the CPU 110.

In the case where filtering on symbols is required, some incoming message formats have the symbol in every message, so the system 100 may parse the message, read the byte location for the symbol, and filter thereupon. In some compacted message formats (e.g., FAST), the first message in a packet of multiple messages may contain the symbol and the following messages do not. In this case, the symbol is stored from the first message and reinserted into the subsequent messages for filtering purposes.

In some message formats, for example ITCH, the symbol may not be in any message within a packet. Instead, the order number for each message is included, which can be cross-referenced to the symbol number, which is stored in a memory (not illustrated) connected to the system 100.

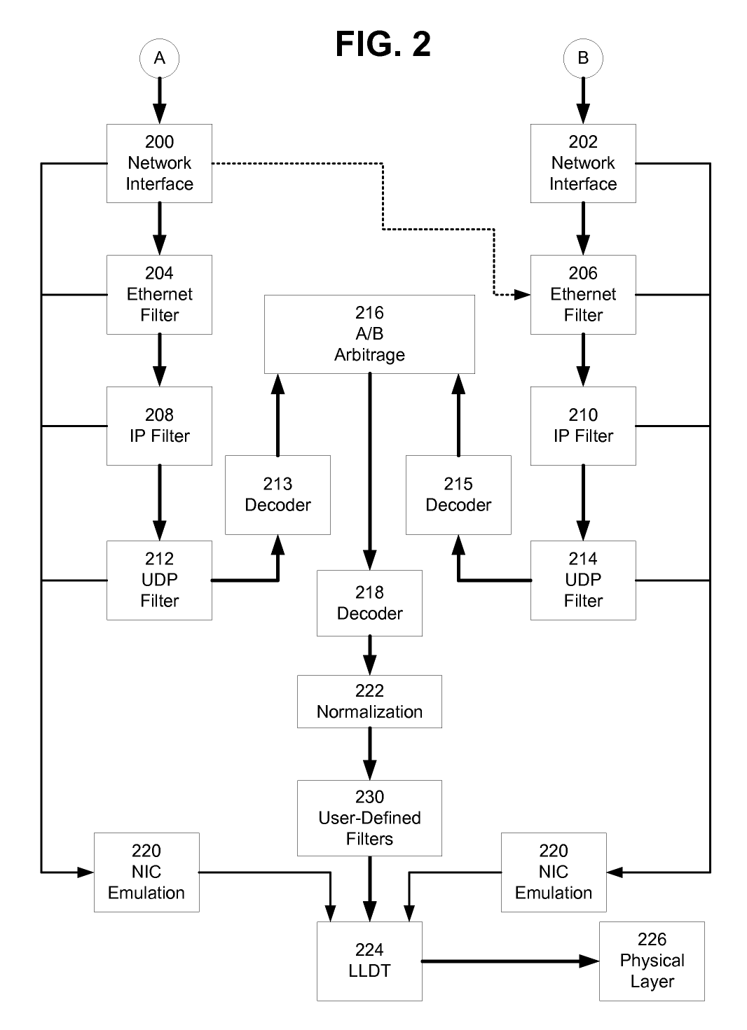

FIG. 2 is a flow diagram illustrating a process by which data streams are processed with low latency according to an embodiment. While two streams and two interfaces are illustrated, this is not meant as a limitation. There can be more than one inbound data stream; thus, there can be multiple network interfaces. Additionally, a single interface (e.g., 200) can be used to provide stream data to the illustrated paths as indicated by the dotted line connect from interface 200 to the Ethernet filter 206.

System 100 reads all data packets that arrive at the network interface and passes the packets through the protocol processing pipeline. At each protocol layer, the headers of the received data packets are inspected to assess whether the source IP address is a known source of financial message data. In an embodiment, data streams A and B maybe redundant streams that will contain the same data.

The system 100 integrates parsing of several protocol layers in parallel using multiple pipelines. A separate pipeline is run for each network port. This means that a complex protocol stack can reliably run at wire-speed (capacity of the physical interface) without missing a single data packet. Importantly, each protocol layer only requires a small number of extra pipeline stages, which may add extra latency (measured in tens of nano-seconds) but with no effect on data throughput. As illustrated in FIG. 2, the standard protocols that are handled in the hardware device include: Ethernet; IP; UDP multicast or unicast, and TCP. However, this is not meant as a limitation. Other protocols may also be handled in a pipeline.

The data streams are received at Ethernet filters (blocks 204 and 206 respectively). Each Ethernet filter operates to filter the network signal. If a data packet does not satisfy the protocol of the Ethernet filters, or if the packets do not come from a known source of financial protocol information, they are either discarded or passed up to the operating system network stack to emulate the behavior of a standard network interface card (NIC) (block 220). This allows the device to exist seamlessly on an existing network, with the operating system handling standard house-keeping protocols such as ARP, ICMP, IGMP, etc., as will be further described below.

The data streams are then passed to IP protocol filters to test the data stream against the internet protocol and to again determine if a packet comes from a known source of financial protocol information (blocks 208 and 210 respectively). If a data packet does not satisfy the protocol of the IP filters, or if the packet does not come from a known source of financial protocol information, the packet is either discarded or passed up to the operating system network stack to emulate the behavior of a standard network interface card (block 220).

The data streams are passed to UDP filters (blocks 212 and 214 respectively). The UDP filters (212 and 214) are employed to test the data stream against the UDP protocol and to determine if a packet comes from a known source of financial protocol information. If the data packet does not satisfy the protocol of the UDP filters, or if the packet does not come from a known source of financial protocol information, the packet is either discarded or passed up to the operating system network stack to emulate the behavior of a standard network interface card at (block 220).

Packets containing financial protocol information are passed through decoders (blocks 213 and 215 respectively) to obtain the feed sequence number and then routed to one of a pair of redundant user datagram protocol (UDP) multicast feeds (A/B Arbitrage block 216) where the packets are assembled into a single stream. The system 100 can read the feeds simultaneously because of the nature of the parallel pipelines for each feed. The system 100 does so by taking the next sequence numbered packet from whichever feed arrives first (sometimes referred to herein as “arbitrage”). If, for example, the next expected packet does not arrive on either feed, the hardware device will generate a flag indicating that there is a gap in the sequence and initiate recovery.

As each numbered packet is processed, it is fed into a single stream where it is directed through a decoder (block 218). The decoder parses the message protocol to obtain financial market data. The financial data is then processed in the appropriate format such as standard FIX (financial information exchange), FAST (FIX adapted for streaming), ASCII or other binary format. The data stream and its component packets are then converted from an ASCII to a binary format for filtering. It is noted that the data may then be either passed onto a software host unprocessed or partially or entirely converted into a binary format as noted herein.

In an embodiment, the data stream may be normalized (block 222). In this embodiment, the financial data parsed from the data stream may be optionally converted into a single format, either proprietary or standard. The normalized format may contain additional fields than that of the incoming format. If that is the case, some fields will not be completed and some may need to be calculated from the incoming data, often via a buffer of data accumulated over multiple messages. Some fields in the incoming format may not have an equivalent in the normalized format, so this data would be dropped.

The data stream may be directed through one or more user-defined filters 230 which may defined by a system user to produce custom formatted data for use by the software subsystem of central processing unit 110. By way of illustration and not by way of limitation, filtering can be performed by symbol, message type, price and volume. In the case where filtering on symbols is required, some incoming message formats have the symbol in every message. In this environment, the user defined filters 230 may read the byte location for the symbol and filter on the location. In some compacted message formats (e.g., FAST), the first message in a packet of multiple messages may contain the symbol and the following messages do not. In this case, the symbol may be stored from the first message and reinserted into the subsequent messages for filtering purposes.

In some message formats, for example ITCH, the symbol may not be in any message within a packet. Instead, the order number for each message is included, which may be cross-referenced to the symbol number, which is stored in a memory (not illustrated).

The filtered data is then sent to the host CPU (execution server) 110 (block 224) utilizing a low latency data transfer (LLDT) API 224 to a physical layer 226 to access the high speed peripheral bus 108. The financial data is sent directly to the execution server 110 of the host system.

In an embodiment, the low-latency data transfer (LLDT) API has both a hardware and software component. The LLDT abstracts communications through any high-speed peripheral bus, such as PCI Express, HyperTransport or QuickPath Interconnect. Transmission of data is carried out via simple calls to the API. Several independent virtual channels may operate over one physical interface; and, data transfer to the host server is via direct memory access. The mixture of hardware and software combined with a consistent API enables a combination of software and hardware solutions (short time to market) to be migrated to hardware over time (for lower latency) with no changes required on the server side.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of a processes or method. Rather, these words are simply used to guide the reader through the description of the methods.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Furthermore, the novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. 112, paragraph 6 to define the invention. To the contrary, if the provisions of 35 U.S.C. 112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. 112, paragraph 6. Moreover, even if the provisions of 35 U.S.C. 112, paragraph 6, are involved to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of the computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (DSL), or wireless technologies such as cellular, infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically and discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein. Further, any reference to claim elements in the singular, for example, using the articles “a,” “an,” or “the,” is not to be construed as limiting the element to the singular.

What is claimed is:

1. A method reducing latency of message data comprising:
directing a first data stream comprising one or more data packets to a first filter stack implemented on a co-processor of a computing device;
directing a second data stream comprising one or more data packets to a second filter stack implemented on a co-processor of a computing device;
processing the first and second data streams in the first and second filter stacks in parallel to identify packets originating from sources of market data;
converting the first and second streams comprising data packets originating from the sources of market data into a combined stream;
decoding the combined stream to obtain financial data;
transforming the combined stream and financial protocol data to a binary representation; and
transferring the transformed data via a high speed peripheral bus to a CPU of a host system.

2. The method of claim 1, wherein processing the first and second data streams in the first and second filter stacks in parallel to identify packets originating from sources of market data comprises:
inspecting each of the one or more data packets of the first and second data streams to determine whether a packet comprises a source IP address associated with a source of market data; and
discarding the packet when the packet does not packet comprises a source IP address associated with a source of market data.

3. The method of claim 1, wherein processing the first and second data streams in the first and second filter stacks in parallel to identify packets originating from sources of market data comprises:
passing each of the one or more data packets of the first and second data streams through a filter, wherein the filter implements a protocol standard; and
discarding the packet when the packet does comply with the protocol standard.

4. The method of claim 3, wherein the filter protocol standard is selected from the group consisting of an Internet protocol, a user datagram protocol (UDP) and a transmission control protocol (TCP).

5. The method of claim 1, wherein decoding the combined stream to obtain the financial data comprises decoding a FIX Adapted for Streaming (FAST) protocol.

6. The method of claim 1, further comprising processing the combined data stream through one or more data filters, wherein the data filters are defined by a system user to filter the financial data to produce custom formatted data for the host system.

7. The method of claim 1, wherein converting the first and second streams comprising financial protocol data packets into a combined stream comprises:
receiving packets at a pair of redundant UDP multicast feeds; and
reading the UDP multicast feeds taking a next sequenced numbered packet from which ever feed arrives first.

8. The method of claim 1, wherein the co-processor is selected from the group consisting of a field programmable gate array and an application specific integrated circuit (ASIC).

9. A system for reducing latency of message data comprising:
one or more network ports for receiving first and second data streams comprised of one or more data packets;
a co-processor, wherein the co-processor comprises first and second filter stacks and wherein the co-processor is configured for:
directing a first data stream comprising one or more data packets to a first filter stack implemented on a co-processor of a computing device;
directing a second data stream comprising one or more data packets to a second filter stack implemented on a co-processor of a computing device;
processing the first and second data streams in the first and second filter stacks in parallel to identify packets originating from sources of market data;
converting the first and second streams comprising data packets originating from the sources of market data into a combined stream;
decoding the combined stream to obtain financial data;
transforming the combined stream and financial protocol data to a binary representation; and
transferring the transformed data via a high speed peripheral bus to a CPU of a host system.

10. The system of claim 9, wherein configuring the co-processor for processing the first and second data streams in the first and second filter stacks in parallel to identify packets originating from sources of market data comprises configuring the co-processor for:
inspecting each of the one or more data packets of the first and second data streams to determine whether a packet comprises a source IP address associated with a source of market data; and
discarding the packet when the packet does not packet comprises a source IP address associated with a source of market data.

11. The system of claim 9, wherein configuring the co-processor for processing the first and second data streams in the first and second filter stacks in parallel to identify packets originating from sources of market data comprises configuring the co-processor for:
passing each of the one or more data packets of the first and second data streams through a filter, wherein the filter implements a protocol standard; and
discarding the packet when the packet does comply with the protocol standard.

12. The system of claim 3, wherein the filter protocol standard is selected from the group consisting of an Internet protocol, a user datagram protocol (UDP) and a transmission control protocol (TCP).

13. The system of claim 9, wherein configuring the co-processor for decoding the combined stream to obtain the financial data comprises configuring the co-processor for decoding a FIX Adapted for Streaming (FAST) protocol.

14. The system of claim 9, wherein the co-processor to further configured for processing the combined data stream through one or more data filters, wherein the data filters are defined by a system user to filter the financial data to produce custom formatted data for the host system.

15. The system of claim 9, wherein configuring the co-processor for converting the first and second streams comprising financial protocol data packets into a combined stream comprises configuring the co-processor for:
receiving packets at a pair of redundant UDP multicast feeds; and
reading the UDP multicast feeds taking a next sequenced numbered packet from which ever feed arrives first.

16. The system of claim 9, wherein the co-processor is selected from the group consisting of a field programmable gate array and an application specific integrated circuit (ASIC).
